(19) United States
(12) Patent Application Publication
(10) Pub. No.: US 2025/0136139 A1
(43) Pub. Date: May 1, 2025

(54) INFORMATION PROCESSING DEVICE, INFORMATION PROCESSING METHOD, AND NON-TRANSITORY, COMPUTER-READABLE RECORDING MEDIUM

(71) Applicant: TOYOTA JIDOSHA KABUSHIKI KAISHA, Toyota-shi Aichi-ken (JP)

(72) Inventors: Kohji SONOHARA, Nagoya-shi Aichi-ken (JP); Katsuyuki SUGITA, Aichi-gun Aichi-ken (JP)

(73) Assignee: TOYOTA JIDOSHA KABUSHIKI KAISHA, Toyota-shi Aichi-ken (JP)

(21) Appl. No.: 18/921,293

(22) Filed: Oct. 21, 2024

(30) Foreign Application Priority Data
Oct. 26, 2023 (JP) 2023-184135

(51) Int. Cl. B60W 50/14; B60W 50/00

(52) U.S. Cl. CPC B60W 50/14; B60W 50/0098; B60W 2050/0083; B60W 2050/143

(57) ABSTRACT

An information processing device includes a reference section that refers to a table in which a list of sounds defined by identifiers determined according to priority levels and sound types is recorded, and an arbitration section that, with respect to emitting instructions from one or more applications that are configured to be capable of being added or updated from an exterior and that cause a sound to be emitted, arbitrates a sound that is to be caused to be emitted, based on the priority levels, and outputs an identifier corresponding to a sound resulting from the arbitration.

### CROSS-REFERENCE TO RELATED APPLICATION

This application is based on and claims priority under 35 USC 119 from Japanese Patent Application No. 2023-184135 filed on Oct. 26, 2023, the disclosure of which is incorporated by reference herein.

### BACKGROUND

### Technical Field

The present disclosure relates to an information processing device, an information processing method, and an information processing program.

### Related Art

There is an increasing trend in the number of external devices installed at a vehicle that output notification information to inform an occupant of the vehicle of various information. In a case in which notification timings of plural information overlap with each other, it is desirable to appropriately control which information is preferentially notified. An example of a technique for outputting an appropriate arbitration result is Japanese Patent Application Laid-Open (JP-A) No. 2019-138791.

### SUMMARY

An information processing device according to an aspect of the present disclosure includes: a memory; and a processor coupled to the memory, wherein the processor is configured to: acquire a reference result of reference to a table in which a list of sounds defined by identifiers determined according to priority levels and sound types is recorded; and with respect to emitting instructions from one or more applications that are configured to be capable of being added or updated from an exterior and that cause a sound to be emitted, arbitrate a sound that is to be caused to be emitted, based on the priority levels, and outputs an identifier corresponding to a sound resulting from the arbitration.

### BRIEF DESCRIPTION OF THE DRAWINGS

Exemplary embodiments of the present disclosure will be described in detail based on the following figures, wherein:

FIG. 1 is a diagram illustrating a schematic configuration of an information processing device according to an exemplary embodiment of the disclosed technology;

FIG. 2 is a diagram illustrating an example of a table referred to by a reference section;

FIG. 3 is a flowchart illustrating a flow of information processing performed by an information processing device; and

FIG. 4 is a diagram explaining a comparative example of one example of exemplary embodiments of the present disclosure.

### DETAILED DESCRIPTION

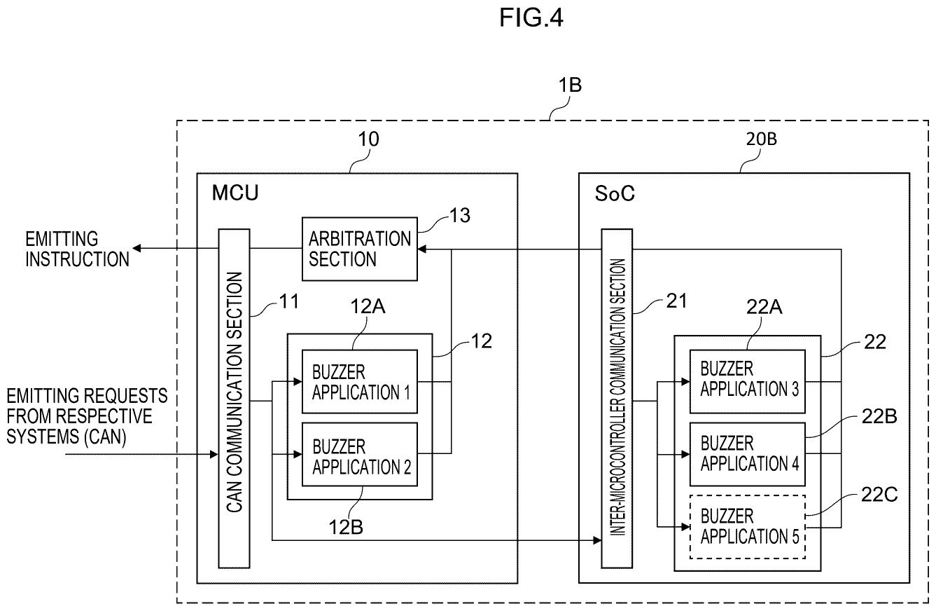

First, the background leading to one example of the exemplary embodiments of the present disclosure will be explained. FIG. 4 is a diagram illustrating a schematic configuration of an information processing device of a comparative example of one example of the exemplary embodiments of the present disclosure. The information processing device 1B illustrated in FIG. 4 is a device that is provided at a vehicle and is a device that receives an emitting request for a sound such as a buzzer or the like from respective systems that are provided at the vehicle via a controller area network (CAN), that interprets the emitting request, and that outputs an emitting instruction for emission of the sound, such as a buzzer or the like, from a speaker (not illustrated in the drawings).

The information processing device 1B is configured by a microcontroller (MCU) 10 and a system-on-chip (SoC) 20B. The MCU 10 and the SoC 20B are each provided with a central processing unit (CPU), a read only memory (ROM), a random access memory (RAM), a storage, and a communication interface (I/F). The information processing device 1B is provided with the MCU 10 for immediacy, responsiveness, and power management, and is provided with the SoC 20 for general-purpose processing such as two-dimensional or three-dimensional graphic processing.

The MCU 10 includes a CAN communication section 11, an application storage section 12, and an arbitration section 13, as functional configuration.

The CAN communication section 11 receives various requests from respective systems provided at the vehicle via the CAN. In particular, the CAN communication section 11 receives emitting requests from the respective systems provided at the vehicle. If an emitting request is an emitting request with respect to an application that is retained at the MCU 10, the CAN communication section 11 sends the emitting request to the application storage section 12, and if the emitting request is an emitting request with respect to an application that is retained at the SoC 20, the CAN communication section 11 sends the emitting request to the SoC 20.

The application storage section 12 stores one or more applications that cause a buzzer to be emitted. In the example in FIG. 4, the application storage section 12 stores two applications (apps) 12A and 12B. Each application outputs an emitting instruction in a case in which an emitting request with respect to the application itself has been sent from the CAN communication section 11. The respective applications stored at the application storage section 12 are applications for causing a safety-related buzzer that requires immediate emission to be emitted. Examples of the safety-related buzzer that requires immediate emission include, for example, a buzzer that notifies an occupant that a seat belt has not been applied. It should be noted that the application storage section 12 cannot be updated from an exterior.

The arbitration section 13 arbitrates emitting instructions from the respective applications that are stored at the application storage section 12, and outputs one emitting instruction through the CAN communication section 11. The arbitration section 13 determines which buzzer to emit in accordance with priority levels for emission when arbitrating the emitting instruction from the respective applications. The arbitration section 13 acquires the priority levels for emission by referring to, for example, a priority level table that is stored at the MCU 10.

The SoC 20B includes an inter-microcontroller communication section 21 and an application storage section 22, as functional configuration.

The inter-microcontroller communication section 21 performs data communication with the MCU 10. In particular, the inter-microcontroller communication section 21 receives emitting requests that have been sent from the MCU 10.

The application storage section 22 stores one or more applications that cause a buzzer to be emitted. In the example in FIG. 4, the application storage section 22 stores two applications (apps) 22A and 22B. Each application outputs an emitting instruction in a case in which an emitting request with respect to the application itself has been sent from the inter-microcontroller communication section 21. The emitting instructions from the applications that are stored at the application storage section 22 are sent to the MCU 10 through the inter-microcontroller communication section 21.

It should be noted that the application storage section 22 can be updated from the exterior. That is to say, the applications that are stored at the application storage section 22 can be updated or added from the exterior by Over The Air (OTA). In the example in FIG. 4, an application 22C is added to the application storage section 22 by OTA. It should be noted that, although the SoC 20B is capable of updating or adding of applications by OTA, the MCU 10 is configured so as not to be capable of updating or adding of applications.

In a case in which the application 22C has been added to the application storage section 22 by OTA, the MCU 10 cannot recognize an emitting instruction from the application 22C that has been added. This is because information related to a priority level of the emitting instruction from the added application 22C does not exist in the table referred to by the arbitration section 13, and therefore, even if the emitting instruction from the application 22C is received, it is not known how the arbitration section 13 should perform arbitration.

In this regard, explanation follows regarding an information processing device configured so that the MCU 10 can recognize an emitting instruction from an application that has been added to the SoC 20, according to an exemplary embodiment of the present disclosure.

An example of an exemplary embodiment of the present disclosure will be explained below with reference to the drawings. It should be noted that the same reference numerals are allocated to same or equivalent constituent elements and portions in the respective drawings. Further, dimensional proportions in the drawings may be exaggerated to aid explanation, and may differ from actual proportions.

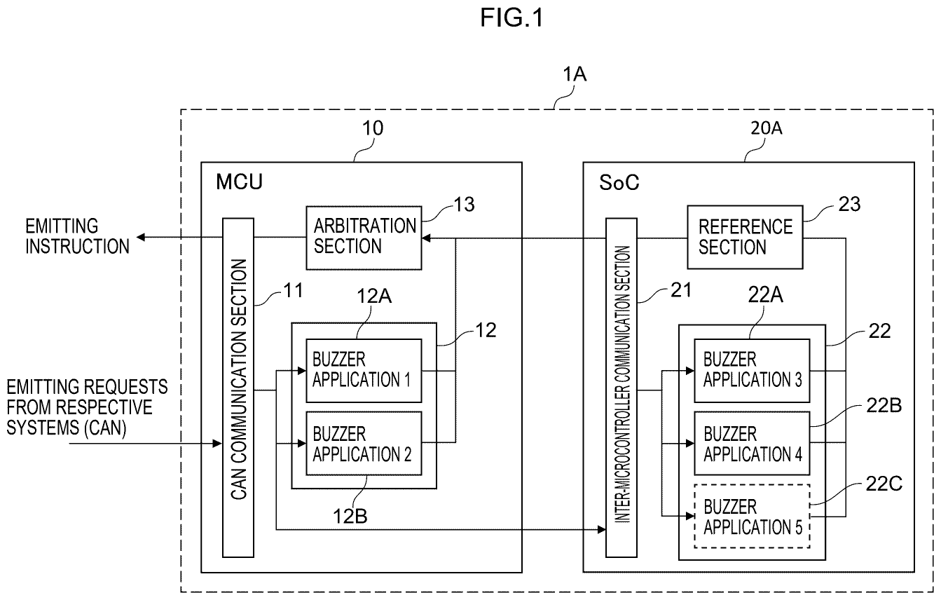

FIG. 1 is a diagram illustrating a schematic configuration of an information processing device according to an exemplary embodiment. Similarly to the information processing device 1B illustrated in FIG. 4 the information processing device 1A illustrated in FIG. 1 is a device that is provided at a vehicle and is a device that receives an emitting request for a buzzer from respective systems provided at the vehicle via the CAN, that interprets the emitting request, and that outputs an emitting instruction for emission of the buzzer from a speaker (not illustrated in the drawings).

The information processing device 1A is configured by the MCU 10 and an SoC 20A. The MCU 10 and the SoC 20Aare each provided with a CPU, a ROM, a RAM, and a communication interface (I/F). The CPU is a central arithmetic processing unit, and the CPU executes various programs and controls various sections. Namely, the CPU reads out programs from the ROM or a storage, and executes the programs using the RAM as a workspace. The CPU carries out control of the aforementioned respective configurations and various arithmetic processing according to programs recorded in the ROM. In the present exemplary embodiment, an information processing program that processes emitting requests from an exterior is stored in the ROM. The ROM stores various programs and various data. The RAM serves as a workspace and temporarily stores programs or data.

The information processing device 1A is provided with the MCU 10 for immediacy, responsiveness, and power management, and is provided with the SoC 20 for general-purpose processing such as two-dimensional or three-dimensional graphic processing. The MCU 10 is a device that is not rewritable, and is an example of a first device of the present disclosure. The SoC 20A is a device that is rewritable, and is an example of a second device of the present disclosure.

The MCU 10 includes the CAN communication section 11, the application storage section 12, and the arbitration section 13, as functional configuration. Since the respective sections are similar to those that were explained for the MCU 10 of the information processing device 1B illustrated in FIG. 4, detailed explanation thereof is omitted. The number of applications that are stored in the application storage section 12 is one or more.

The SoC 20A includes the inter-microcontroller communication section 21, the application storage section 22, and a reference section 23, as functional configuration.

The inter-microcontroller communication section 21 performs data communication with the MCU 10. In particular, the inter-microcontroller communication section 21 receives emitting requests that have been sent from the MCU 10.

The application storage section 22 stores one or more applications that cause a buzzer to be emitted. In the example in FIG. 1, the application storage section 22 stores two applications (apps) 22A and 22B. Each application outputs an emitting instruction to the reference section 23 in a case in which an emitting request with respect to the application itself has been sent from the inter-microcontroller communication section 21.

The applications that are stored in the application storage section 22 can be updated or added from the exterior by OTA. In the example in FIG. 1, an application 22C is added to the application storage section 22 by OTA. It should be noted that, similarly to the information processing device 1B in FIG. 4, the SoC 20A is configured so as to be capable of updating or adding of an application by OTA, but the MCU 10 is configured so as not to be capable of updating or adding of an application.

When the reference section 23 acquires an emitting instruction from an application that is stored at the application storage section 22, the reference section 23 refers to a table in which a list of buzzers defined by identifiers determined according to priority levels and sound types is recorded. This table is recorded at the SoC 20. The reference section 23 then refers to the table, and outputs an emitting instruction for a buzzer having a high priority level to the MCU 10 through the inter-microcontroller communication section 21. At the MCU 10, a reference result from the reference section 23 is acquired by the arbitration section 13. Accordingly, the arbitration section 13 can also function as an acquisition section of the present disclosure.

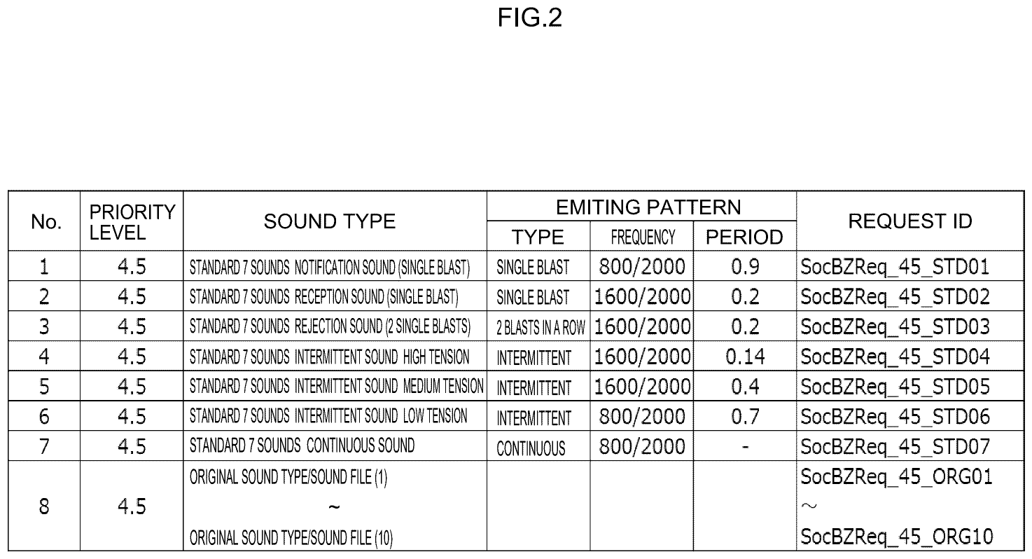

FIG. 2 is a diagram illustrating an example of a table referred to by the reference section 23. A unique request ID is set in the table in accordance with the priority level and the sound type of the buzzer. That is to say, the request ID is an ID that is determined based on the priority level, and is an example of an identifier of the present disclosure. When the reference section 23 acquires an emitting instruction from an application that is stored at the application storage section 22, the reference section 23 refers to the table illustrated in FIG. 2, and outputs a request ID corresponding to the buzzer as an emitting instruction for a buzzer having a high priority level. This request ID is used for arbitration at the arbitration section 13.

For example, when emitting instructions are respectively output from the applications 22A, 22B, and 22C at the same timing, the reference section 23 refers to the table illustrated in FIG. 2, and outputs a request ID as an emitting instruction for a buzzer having a high priority level. In other words, the reference section 23 abstracts an emitting instruction from an application stored at the application storage section 22, and outputs this to the MCU 10. More specifically, abstracting an emitting instruction is abstracting for a sound type that has been determined in advance at the SoC 20A. Due to the emitting instruction from the application stored at the application storage section 22 being abstracted, even in a case in which an application has been added to the SoC 20, the arbitration section 13 can recognize the emitting instruction from the added application.

Due to the information processing device 1A according to the exemplary embodiment of the present disclosure having such a configuration, an emitting instruction from an application can be recognized and a buzzer can be caused to be emitted, even in a case in which the application that causes the buzzer to be emitted has been added or updated.

Next, operation of the information processing device 1A will be explained.

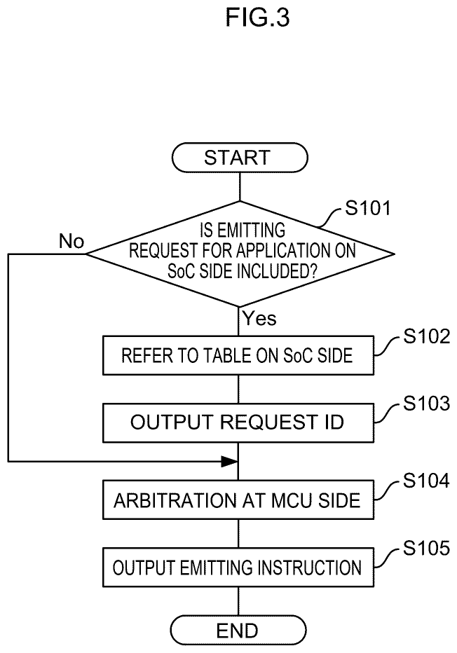

FIG. 3 is a flowchart illustrating a flow of information processing performed by the information processing device 1A. The information processing is performed due to the CPU of each of the MCU 10 and the SoC 20A reading out an information processing program from the ROM or a storage and expanding and executing the information processing program in the RAM.

When the information processing device 1A acquires emitting requests for buzzers from the respective systems provided at the vehicle via the CAN, at step S101, it is determined at the MCU 10 whether or not an emitting request for an application on the SoC 20A side is included.

As a result of the determination at step S101, in a case in which an emitting request for an application on the SoC 20A side is included (step S101: Yes), then at step S102, the information processing device 1A refers to the table recorded at the SoC 20A in order to arbitrate the emitting instructions based on the emitting request for the application on the SoC 20A side.

Following step S102, at step S103, as a result of referring to the table, the information processing device 1A acquires the request ID of the buzzer having the highest priority level, and outputs this to the MCU 10 from the SoC 20A.

Following step S103, at step S104, the information processing device 1A arbitrates, at the MCU 10, emitting instructions from both the applications on the MCU 10 side and the applications on the SoC 20A side. It should be noted that, as a result of the determination at step S101, in a case in which an emitting request for an application on the SoC 20A side is not included (step S101: No), then at step S104, the information processing device 1A arbitrates, at the MCU 10, emitting instructions for the applications on the MCU 10 side.

Following step S104, at step S105, the information processing device 1A outputs one emitting instruction as a result of arbitration of the emitting instructions.

Due to the information processing device 1A according to the exemplary embodiment of the present disclosure executing such processing, an emitting instruction from an application can be recognized and a buzzer can be caused to be emitted, even in a case in which the application that causes the buzzer to be emitted has been added or updated.

Although exemplary embodiments of the present disclosure have been explained in detail above with reference to the accompanying drawings, the technical scope of the present disclosure is not limited to such examples. It will be clear that various changes and modifications can be conceived of by those having ordinary skill in the technical field of the present disclosure within the scope of the technical ideas set forth in the patent claims, and it will be understood that these changes and modifications also naturally fall within the technical scope of the present disclosure.

Further, the effects described in the above exemplary embodiments are explanatory or illustrative, and effects are not limited to those that have been described in the above exemplary embodiments. That is to say, the technology according to the present disclosure may exert other effects that will be apparent to those having ordinary skill in the technical field of the present disclosure from the description of the above exemplary embodiments, in addition to the effects described in the above exemplary embodiments or in place of the effects described in the above exemplary embodiments.

It should be noted that the information processing executed by a CPU reading and executing software (a program) in the above exemplary embodiments may be executed by various types of processors other than a CPU. Such processors include programmable logic devices (PLD) that allow circuit configuration to be modified post-manufacture, such as a field-programmable gate array (FPGA) or the like, and dedicated electric circuits, which are processors including a circuit configuration that has been custom-designed to execute specific processing, such as an application specific integrated circuit (ASIC) or the like. Further, the information processing may be executed by any one of these various types of processors, or may be executed by a combination of two or more of the same type or different types of processors (such as, for example, plural FPGAs, a combination of a CPU and an FPGA, or the like). Furthermore, the hardware structure of these various types of processors is, more specifically, an electric circuit combining circuit elements such as semiconductor elements or the like.

Further, although explanation has been given regarding an aspect in which information processing programs are stored (installed) in advance in a ROM in the above exemplary embodiments, there is no limitation thereto. The programs may be provided in a format recorded on a non-transitory recording medium such as a compact disc read only memory (CD-ROM), a digital versatile disc read only memory (DVD-ROM), a universal serial bus (USB) memory, or the like. Alternatively, the programs may be provided in a format downloadable from an external device via a network.

In the case of a two-chip configuration in which a system of a vehicle is configured by a microcontroller (MCU) and a system-on-chip (SoC), even if an application is added to the SoC, the MCU cannot recognize an output instruction, from the application that has been added to the SoC, for providing notification to an occupant with a sound such as a buzzer or the like. This is because the MCU cannot recognize the application that has been added to the SoC.

The present disclosure has been made in consideration of the above points, and an object thereof is to provide an information processing device, an information processing method, and an information processing program capable of recognizing an emitting instruction from an application and causing a sound to be emitted even in a case in which the application, which causes a sound such as a buzzer or the like to be emitted, has been added or updated.

An information processing device according to a first aspect of the present disclosure includes: a memory; and a processor coupled to the memory, wherein the processor is configured to: acquire a reference result of reference to a table in which a list of sounds defined by identifiers determined according to priority levels and sound types is recorded; and with respect to emitting instructions from one or more applications that are configured to be capable of being added or updated from an exterior and that cause a sound to be emitted, arbitrate a sound that is to be caused to be emitted, based on the priority levels, and outputs an identifier corresponding to a sound resulting from the arbitration.

According to the first aspect of the present disclosure, arbitration is carried out with respect to the emitting instructions from the one or more applications that are configured to be capable of being added or updated from an exterior and that cause a sound to be emitted, whereby, even in a case in which an application that causes a sound to be emitted has been added or updated, an emitting instruction from that application can be recognized, and the sound can be caused to be emitted.

An information processing device according to a second aspect of the present disclosure is the information processing device according to the first aspect, wherein the processor is configured to arbitrate a sound that is to be caused to be emitted, based on the priority levels, with respect to an emitting instruction corresponding to the output identifier and an emitting instruction from an application that is configured to not be capable of being added or updated, and outputs an identifier corresponding to a sound resulting from the arbitration.

According to the second aspect of the present disclosure, even in a case in which an application that causes a sound to be emitted has been added or updated, the sound that is to be caused to be emitted can be arbitrated based on a priority level of that application.

An information processing device according to a third aspect of the present disclosure is the information processing device according to the first aspect or the second aspect, wherein the information processing device includes a first device that is not rewritable and a second device that is rewritable, and the identifier is output from the second device to the first device.

According to the third aspect of the present disclosure, arbitration is carried out with respect to an emitting instruction from an application that has been added or updated at the rewritable second device, whereby, even in a case in which an application that causes a sound to be emitted has been added or updated, an emitting instruction from that application can be recognized, and the sound can be caused to be emitted.

In an information processing method according to a fourth aspect of the present disclosure, a processor performs processing that includes: acquiring a reference result of reference to a table in which a list of sounds defined by identifiers determined according to priority levels and sound types is recorded; and, with respect to emitting instructions from one or more applications that are configured to be capable of being added or updated from an exterior and that cause a sound to be emitted, arbitrating a sound that is to be caused to be emitted, based on the priority levels, and outputting an identifier corresponding to a sound resulting from the arbitration.

According to the fourth aspect of the present disclosure, arbitration is carried out with respect to the emitting instructions from the one or more applications that are configured to be capable of being added or updated from an exterior and that cause a sound to be emitted, whereby, even in a case in which an application that causes a sound to be emitted has been added or updated, an emitting instruction from that application can be recognized, and the sound can be caused to be emitted.

A non-transitory recording medium storing a program according to a fifth aspect of the present disclosure is executable by a computer to perform processing that includes: acquiring a reference result of reference to a table in which a list of sounds defined by identifiers determined according to priority levels and sound types is recorded; and, with respect to emitting instructions from one or more applications that are configured to be capable of being added or updated from an exterior and that cause a sound to be emitted, arbitrating a sound that is to be caused to be emitted, based on the priority levels, and outputting an identifier corresponding to a sound resulting from the arbitration.

According to the fifth aspect of the present disclosure, arbitration is carried out with respect to the emitting instructions from the one or more applications that are configured to be capable of being added or updated from an exterior and that cause a sound to be emitted, whereby, even in a case in which an application that causes a sound to be emitted has been added or updated, an emitting instruction from that application can be recognized, and the sound can be caused to be emitted.

According to the present disclosure, it is possible to provide an information processing device, an information processing method, and an information processing program capable of recognizing an emitting instruction from an application and causing a sound to be emitted even in a case in which the application, which causes the sound to be emitted, has been added or updated.

What is claimed is:

1. An information processing device comprising:
a memory; and
a processor coupled to the memory, wherein the processor is configured to:
acquire a reference result of reference to a table in which a list of sounds defined by identifiers determined according to priority levels and sound types is recorded; and
with respect to emitting instructions from one or more applications that are configured to be capable of being added or updated from an exterior and that cause a sound to be emitted, arbitrate a sound that is to be caused to be emitted, based on the priority levels, and outputs an identifier corresponding to a sound resulting from the arbitration.

2. The information processing device according to claim 1, wherein the processor is configured to arbitrate a sound that is to be caused to be emitted, based on the priority levels, with respect to an emitting instruction corresponding to the output identifier and an emitting instruction from an application that is configured to not be capable of being added or updated, and outputs an identifier corresponding to a sound resulting from the arbitration.

3. The information processing device according to claim 1, comprising a first device that is not rewritable, and a second device that is rewritable,
wherein the identifier is output from the second device to the first device.

4. An information processing method in which a processor performs processing, the processing comprising:
acquiring a reference result of reference to a table in which a list of sounds defined by identifiers determined according to priority levels and sound types is recorded; and
with respect to emitting instructions from one or more applications that are configured to be capable of being added or updated from an exterior and that cause a sound to be emitted, arbitrating a sound that is to be caused to be emitted, based on the priority levels, and outputting an identifier corresponding to a sound resulting from the arbitration.

5. A non-transitory recording medium storing a program that is executable by a computer to perform processing, the processing comprising:
acquiring a reference result of reference to a table in which a list of sounds defined by identifiers determined according to priority levels and sound types is recorded; and
with respect to emitting instructions from one or more applications that are configured to be capable of being added or updated from an exterior and that cause a sound to be emitted, arbitrating a sound that is to be caused to be emitted, based on the priority levels, and outputting an identifier corresponding to a sound resulting from the arbitration.
